(19) United States
(12) Patent Application Publication
(10) Pub. No.: US 2026/0061904 A1
(43) Pub. Date: Mar. 5, 2026

(54) CHILD RESTRAINT

(71) Applicant: Shanghai Dorel Juvenile Company, Ltd., Shanghai (CN)

(72) Inventors: Shaofeng HUANG, Shanghai (CN); Chengsheng ZHENG, Shanghai (CN)

(21) Appl. No.: 19/314,729

(22) Filed: Aug. 29, 2025

(30) Foreign Application Priority Data
Aug. 30, 2024 (CN) 202411210338.X
Aug. 30, 2024 (CN) 202422135481.9
Nov. 5, 2024 (CN) 20243097678.4

(51) Int. Cl. B60N 2/28

(52) U.S. Cl. CPC B60N 2/289

(57) ABSTRACT

A child restraint includes a seat base adapted to rest on a vehicle seat and a juvenile seat coupled to the seat base. The juvenile seat is formed to include a child receiving space configured to receive a child to support the child for transportation in a vehicle. The child restraint further includes a seat anchor coupled to the seat base and configured to attach to a vehicle seat anchor point to at least partially secure the child restraint to the vehicle seat.

### PRIORITY CLAIM

This application claims priority to Chinese Utility Model Application No. CN202422135481.9, filed Aug. 30, 2024, Chinese Application No. CN202411210338.X, filed Aug. 30, 2024, Chinese Industrial Design Application No. CN20243097678.4, filed Nov. 5, 2024, each of which is hereby incorporated in its entirety herein.

### BACKGROUND

The present disclosure relates to child safety device, and particularly to a child restraint. More particularly, the present disclosure relates to a child restraint configured to be used in a vehicle.

### SUMMARY

According to the present disclosure, a child restraint includes a seat base adapted to rest on a vehicle seat and a juvenile seat coupled to the seat base. The juvenile seat is formed to include a child receiving space configured to receive a child to support the child for transportation in a vehicle.

In illustrative embodiments, the child restraint further includes a seat anchor coupled to the seat base and configured to attach to a vehicle seat anchor point to at least partially secure the child restraint to the vehicle seat. The seat anchor includes an anchor housing coupled to the seat base for movement therewith, a latch motion controller coupled to the anchor housing, a first anchor latch coupled to a first end of the latch motion controller, and a second anchor latch coupled to an opposite second end of the latch motion controller.

In illustrative embodiments, the seat base, the juvenile seat, and the seat anchor are movable in unison between a forward-facing arrangement and a rearward-facing arrangement. The latch motion controller, the first anchor latch, and the second anchor latch are configured to translate relative to seat base, the juvenile seat, and the anchor housing from a forward-facing attachment configuration and a rearward-facing attachment configuration. In the forward-facing attachment configuration, the first anchor latch is withdrawn from the anchor housing for attachment with the vehicle seat anchor point and the second anchor latch is received in the anchor housing when the child restraint is in the forward-facing arrangement. In the rearward-facing attachment configuration, the first anchor latch is received in the anchor housing and the second anchor latch is withdrawn from in the anchor housing for attachment with the vehicle seat anchor point when the child restraint is in the rearward-facing arrangement.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a child restraint in accordance with the present disclosure including a seat base, a juvenile seat coupled to the seat base and configured to support a child, and a seat anchor coupled to the seat base and configured to at least partially secure the child restraint to a vehicle seat for transportation in a vehicle;

FIG. 2 is a side elevation and diagrammatic view of the child restraint of FIG. 1 in a forward-facing arrangement showing the seat anchor in a forward-facing attachment configuration in which a first anchor latch included in the seat anchor is positioned for attachment to a vehicle seat anchor point when the child restraint is in the forward-facing arrangement;

FIG. 3 is a side elevation and diagrammatic view of the child restraint of FIG. 1 in a rearward-facing arrangement showing the seat anchor in a rearward-facing attachment configuration in which a second anchor latch included in the seat anchor is positioned for attachment to the vehicle seat anchor point when the child restraint is in the rearward-facing arrangement;

FIG. 4 is a perspective view of a portion of the child restraint of FIG. 1 showing the seat anchor in the forward-facing attachment configuration;

FIG. 5 is a perspective view of a portion of the child restraint of FIG. 1 showing the seat anchor in a storage configuration in which the first and second anchor latches are withdrawn into a storage space formed in the seat base;

FIG. 6 is a perspective view of a portion of the child restraint of FIG. 1 showing the seat anchor in the rearward-facing attachment configuration;

FIG. 7 is a perspective view of one of the seat anchors including an anchor housing, a latch motion controller coupled to the anchor housing to control movement of the first and second anchor latches relative to the anchor housing, and the first and second anchor latches attached to the latch motion controller at respective ends thereof;

FIG. 8 is a perspective view of the seat anchor of FIG. 7 with portions of the anchor housing and the latch motion controller removed to show the latch motion controller including a carrier slidably coupled with the anchor housing, a first latch lock coupled with the carrier and the first anchor latch, a second latch lock coupled with the carrier and the second anchor latch, and a release actuator interconnecting the first and second latch locks to control movement of both anchor latches and both latch locks from a single actuation point, and showing each latch lock in a locked position with the anchor housing to block translation of the carrier and the first and second anchor latches relative to the anchor housing;

FIG. 9 is a cross section taken along a longitudinal plane of the seat anchor of FIG. 7 showing a side view of the seat anchor and the latch locks in the locked position;

FIG. 10 is a cross section taken along a longitudinal plane of the seat anchor of FIG. 7 showing a top view of the seat anchor and the release actuator in an unactuated configuration;

FIG. 11 is a perspective view of the latch motion controller of the seat anchor of FIG. 7 with portions of the carrier removed to show the latch locks and the anchor latches in detail;

FIG. 12 is a perspective view of the seat anchor of FIG. 7 with portions of the anchor housing and the carrier removed and showing the latch locks each in an unlocked position separating a lock tab included each latch lock from the anchor housing to free the carrier and the first and second anchor latches for translation relative to the anchor housing between the forward-facing attachment configuration and the rearward-facing attachment configuration;

FIG. 13 is a cross section taken along a longitudinal plane of the seat anchor of FIG. 12 showing each latch lock in the unlocked position;

FIG. 14 is a cross section of the latch motion controller taken along the longitudinal plane showing the latch locks in the locked position;

FIG. 15 is a perspective view of the seat anchor of FIG. 7 showing one of the anchor latches in a locked position and showing the corresponding latch lock positioned to block movement of the anchor latch to a released position;

FIG. 16 is a cross section taken along a longitudinal plane of the seat anchor of FIG. 15 showing one of the anchor latches in the locked position and showing the corresponding lock tab in the unlocked position where the latch motion controller and the anchor latches are blocked from translating in a first direction by the other lock tab and in a second direction opposite the first direction by portions of the child restrain abutting against the vehicle seat;

FIG. 17 is a cross section of the release actuator including a first actuator pin coupled to the first latch lock, a second actuator pin coupled to the second latch lock, a first actuator pad coupled to the first actuator pin for movement therewith, a second actuator pad coupled to the second actuator pin for movement therewith, and an actuator lock coupled to one of the first actuator pad and the second actuator pad and configured to engage the other of the first actuator pad and the second actuator pad in a locked position to block translation thereof;

FIG. 18 is a cross section of the release actuator showing the actuator lock in a released position freeing the first actuator pad and the second actuator pad for translation relative to one another to cause movement of the first and second latch locks to unlock each of the anchor latches and the carrier for movement relative to the anchor housing;

FIG. 19 is a cross section of a second embodiment of a release actuator in a locked configuration; and

FIG. 20 is a cross section of the release actuator of FIG. 19 in an unlocked configuration.

### DETAILED DESCRIPTION

A child restraint 100 includes a seat shell 102 adapted to rest on a vehicle seat 101 and formed to include a child receiving space 104 configured to receive a child to support the child for transportation in a vehicle. In some embodiments, the seat shell 102 includes a seat base 106 and a juvenile seat 108 coupled to the seat base 106. The juvenile seat 108 is formed to include the child receiving space 104. The seat base 106 is configured to rest on the vehicle seat 101 to support the juvenile seat 108 relative to the vehicle seat.

In illustrative embodiments, the child restraint 100 further includes a pair of seat anchors 110 coupled to the seat shell 102 and configured to attach selectively to a vehicle seat anchor point (i.e. an isofix connection point) to at least partially secure the child restraint 100 to the vehicle seat 101. Each seat anchor 110 is dual sided and includes a first anchor latch 2 and a second anchor latch 2′. The first anchor latch 2 and the second anchor latch 2′ are movable relative to the seat shell 102 to attach the first anchor latch 2 to the vehicle seat anchor point when the seat shell 102 is in a forward-facing arrangement, as shown in FIG. 2, and the second anchor latch 2′ to the vehicle seat anchor point when the seat shell 102 is in a rearward-facing arrangement as shown in FIG. 3. The juvenile seat 108 is reclinable relative to the seat base 106 so that the juvenile seat 108 can assume an upright orientation in the forward-facing arrangement and a reclined orientation in the rearward-facing arrangement.

Each seat anchor 110 includes an anchor housing 7 coupled to the seat shell 102 for movement therewith, an latch motion controller 114 coupled to the anchor housing 7, the first anchor latch 2 coupled to a first end of the latch motion controller 114, and the second anchor latch 2′ coupled to an opposite second end of the latch motion controller 114. The anchor housing 7 secures the seat anchor 110 in place when the latch motion controller 114 is in a locked position to block movement of at least one of the latches 2, 2′ relative to the seat shell 102. The latch movement controller 114 is configured to control movement of latches 2, 2′ both: (i) between a locked position engaged with the vehicle seat anchor point and a released position disengaged from the vehicle seat anchor point, and (ii) between a forward-facing attachment configuration to position the first anchor latch for attachment with the vehicle seat anchor point and a rearward-facing attachment configuration to position the second anchor latch for attachment with the vehicle seat anchor point.

The anchor housing 7 at least partially defines a storage cavity 120. The second anchor latch 2′ is received in the storage cavity 120 in the forward-facing attachment configuration and the first anchor latch 2 is received in the storage cavity 120 in the rearward-facing attachment configuration. In some embodiments, the anchor housing 7 is integrated into the seat shell 102 such that the storage cavity 120 is formed in the seat shell 102, such as in the seat base 106. In some embodiments, the anchor housing includes a tubular structure configured to receive the carrier 1 therein. In other embodiments, both the anchor housing 7 and the carrier 1 include a rail that interface with one another.

The seat shell 102 and the seat anchors 110 are movable in unison between the forward-facing arrangement in which the child-receiving space 104 faces in a forward direction of the vehicle, as shown in FIG. 2, and the rearward-facing arrangement which the child-receiving space 104 faces in a rearward direction of the vehicle opposite the forward direction, as shown in FIG. 3. The latch motion controller 114, the first anchor latch 2, and the second anchor latch 2′ are configured to move relative to seat shell 102 and the anchor housing 7 from the forward-facing attachment configuration to the rearward-facing attachment configuration. In the forward-facing attachment configuration, the first anchor latch 2 is withdrawn from the anchor housing 7 and/or the seat shell 102 for attachment with the vehicle seat anchor point and the second anchor latch 2′ is received in the anchor housing 7 and/or the seat shell 102 when the child restraint 100 is in the forward-facing arrangement. In the rearward-facing attachment configuration, the first anchor latch 2 is received in the anchor housing 7 and the second anchor latch 2′ is withdrawn from in the anchor housing 7 for attachment with the vehicle seat anchor point when the child restraint 100 is in the rearward-facing arrangement. The latch motion controller 114 is further movable relative to the anchor housing 7 to a storage configuration in which the first anchor latch 2 and the second anchor latch 2′ are both withdrawn into the anchor housing 7.

The first anchor latch 2 and the second anchor latch 2′ are configured to move in unison relative to the seat shell 102 in a first direction away from the second latch anchor 2′ and when the child restraint 100 is in the forward-facing arrangement to position the first anchor latch 2 for attachment with the vehicle seat anchor point in the forward-facing attachment configuration. The first anchor latch 2 and the second anchor latch 2′ are configured to move in unison relative to the seat shell 102 in a second direction away from the first latch anchor 2 and when the child restraint 100 is in the rearward-facing arrangement to position the second anchor latch 2′ for attachment with the vehicle seat anchor point in the rearward-facing attachment configuration.

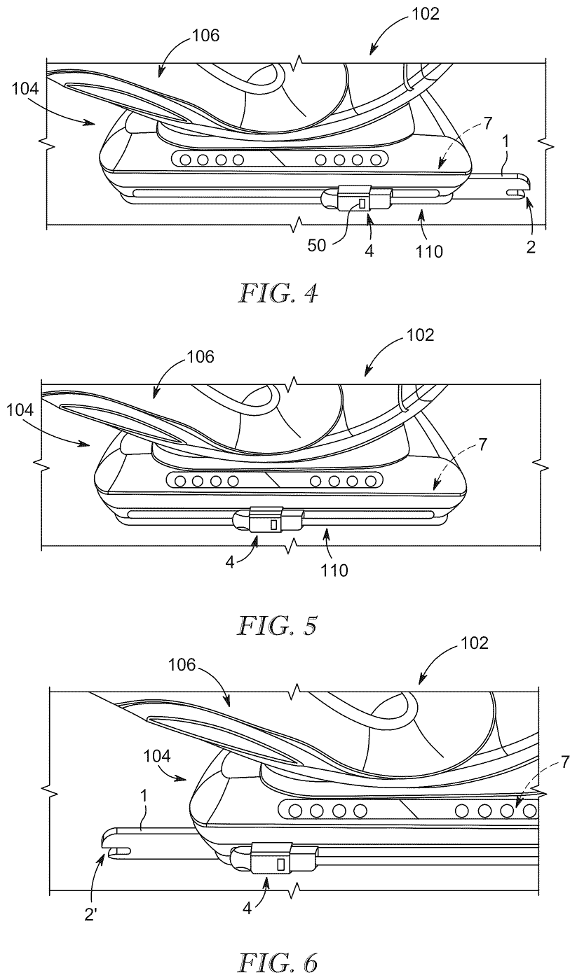

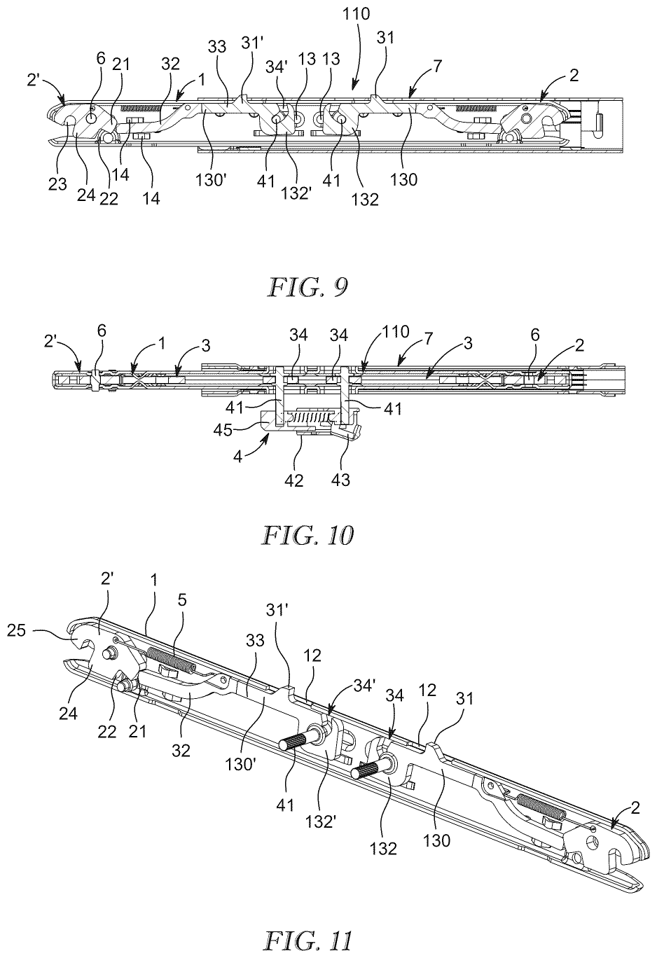

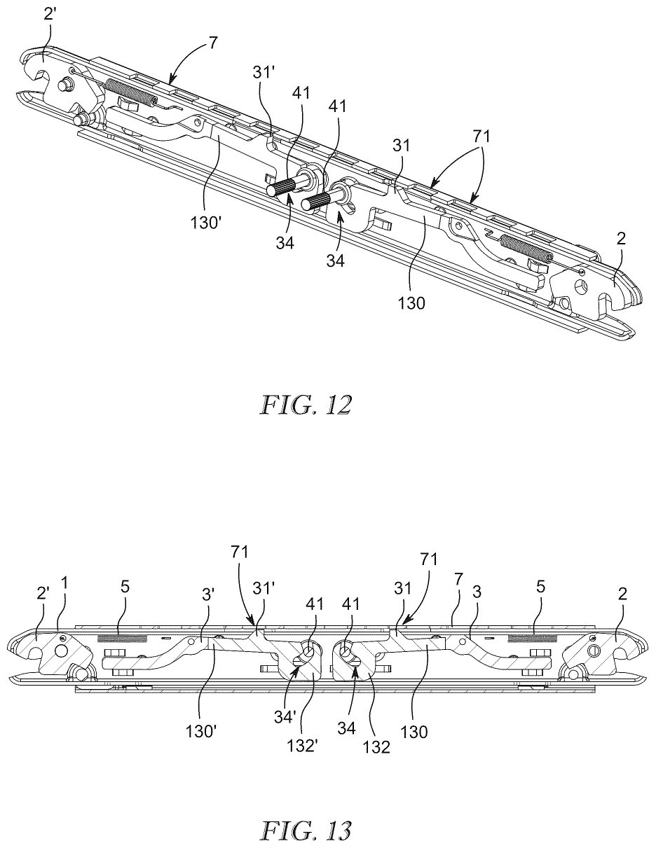

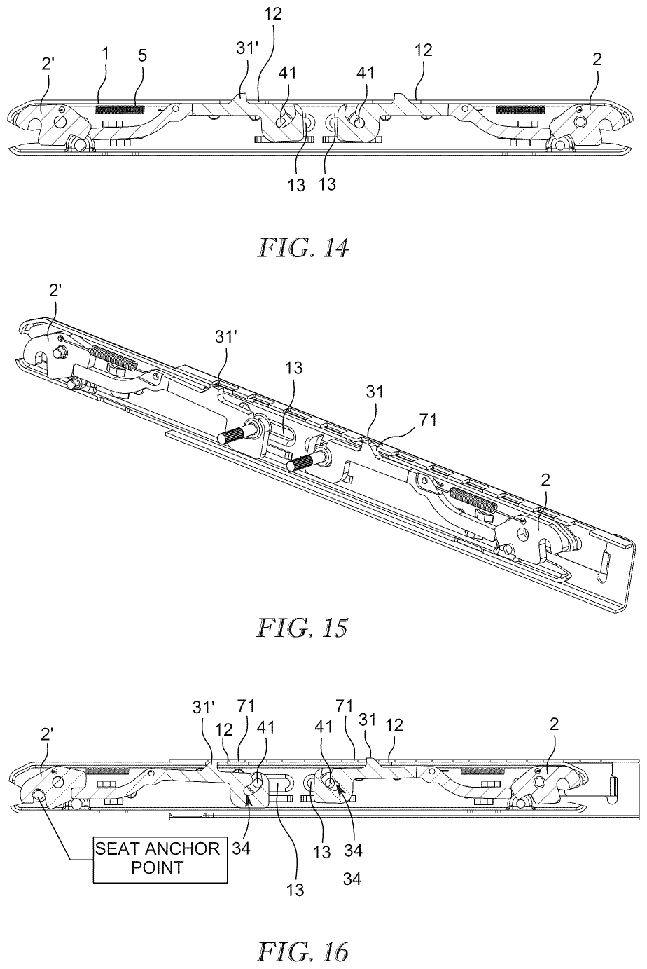

The latch motion controller 114 includes a carrier 1 (also called an installation housing 1) having the first end and the opposite second end, a first latch lock 3 coupled to the carrier 1, and a second latch lock 3′ coupled to the carrier 1 and spaced apart from the first latch lock 3 along a length of the carrier 1 as shown in FIGS. 4-16. The first latch lock 3 is configured to move the first anchor latch 2 from a locked position engaged with the vehicle seat anchor point in the forward-facing arrangement to a released position freeing the first anchor latch 2 from the vehicle seat anchor point. The second latch lock 3′ is configured to move the second anchor latch 2′ from a locked position engaged with the vehicle seat anchor point in the rearward-facing arrangement to a released position freeing the second anchor latch from the vehicle seat anchor point

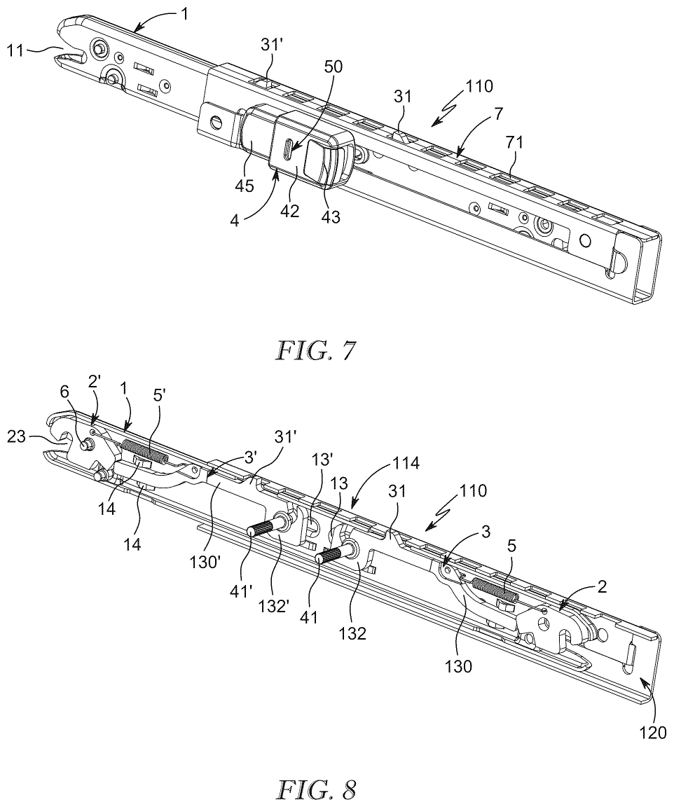

The latch motion controller 114 further includes a release actuator 4 as shown in FIG. 7. The release actuator 4 extends between the first latch lock 3 and the second latch lock 3′ and is configured to be gripped and actuated by a user to move the first and second latch locks 3, 3′ to cause movement of at least one of the first anchor latch 2 and the second anchor latch 2′ from the locked position to the released position.

The first latch lock 3 and the second latch lock 3′ each include a lock arm 130, 130′, an arm-motion guide 132, 132′ coupled to the lock arm 130, 130′, and a lock tab 31, 31′ coupled to the lock arm 130, 130′. Each lock arm 130, 130′ is configured to engage each respective anchor latch 2, 2′ when each respective anchor latch 2, 2′ is in the locked position to block movement of each respective anchor latch 2, 2′ from the locked position to the released position. The arm-motion guides 132, 132′ are coupled with the release actuator 4 and are configured to be moved by the release actuator 4 to cause movement of each lock arm 130, 130′ relative to each respective latch lock 2, 2′. The lock tabs 31, 31′ are coupled to each respective lock arm 130, 130′ and are configured to engage selectively with the anchor housing 7 to block translation of the latch motion controller 114 and the first and second anchor latches 2, 2′ relative to the anchor housing 7.

Each arm-movement guide 132, 132′ is formed to include a guide slot 34, 34′ that receives a portion of the release actuator 4. The guide slots 34, 34′ are shaped to cause movement of the lock arm 130, 130′ and the lock tab 31, 31′ in a multiple directions in response to movement of at least a portion of the release actuator 4. Specifically, actuation of release actuator 4 in a direction parallel with a translation direction of the carrier 1 is configured to cause movement of the lock arms 130, 130′ in a direction generally parallel to the travel direction of the carrier 1. Actuation of release actuator 4 in the direction parallel with a translation direction of the carrier 1 is also configured to cause movement of at least a portion of the lock arms 130, 130′ and the lock tabs 31, 31′ in a direction generally perpendicular to the travel direction of the carrier 1. The guide slots 34, 34′ are shaped to pull the lock arms 130, 130′ inwardly away from the latches 2, 2′ to disengage the lock arms 130, 130′ from the latches 2, 2′ so that the latches 2, 2′ are free to return to the unlocked position. The guide slots 34, 34′ are also shaped to pull the lock tabs 31, 31′ downward away from apertures 71 formed in the anchor housing 7 to free the carrier 1, the latches 2, 2′ and the latch movement controller 114 for translation relative to the housing 7 in the travel direction.

In the illustrative embodiment, the lock tabs 31, 31′ are formed integrally with each respective lock arm 130, 130′ so as to move therewith. In other embodiments, the lock tabs 31, 31′ may be formed on a separate component from the lock arms 31, 31′ and movable relative to the lock arms 31, 31′.

A method of installing the child restraint 100 includes attaching one of the first anchor latch 2 or the second anchor latch 2′ to the vehicle seat anchor point. If the first anchor latch 2 is attached, the second latch lock 3′ blocks movement of the child restraint away from the vehicle seat anchor point. If the second anchor latch 2′ is attached, the first latch lock 3 blocks movement of the child restraint 100 away from the vehicle seat anchor point. When one of the anchor latches 2, 2′ are locked with the vehicle seat anchor point, the corresponding latch lock 3, 3′ is released from the anchor housing 7. This allows a user to press on the child restraint 100 to move the shell 102 closer to the vehicle seat anchor point to tighten the connection between the seat anchor 110 and the vehicle seat anchor point. In other words, the method further includes moving the child restraint 100 toward the vehicle seat anchor point while the one of the first anchor latch 2 and the second anchor latch 2′ is attached to the vehicle seat anchor point to decrease a distance between the anchor housing 7 and the vehicle seat anchor point.

In some embodiments, the seat anchor 110 further includes an indicator 50 configured to display an indication when at least one of the first anchor latch 2 and the second anchor latch 2′ is in a predetermined position relative to the anchor housing 7. In one example, the predetermined position corresponds with the lock tabs 31, 31′ being received in a corresponding aperture 71 formed in the housing 7 to indicate that the seat anchor 110 is locked and/or secured. In another example, the predetermined position corresponds with at least one latch 2, 2′ being in the locked position. The indicator 50 may move relative to a window formed on the release actuator 4 to display one of a plurality of colors through the window. For example, a portion of the indicator 50 may include a red color that is displayed through the window when the seat anchor 110 is not fully locked or secured, and a second portion of the indicator 50 may include a green color that is displayed through the window when the seat anchor 110 is fully locked or secured.

The release actuator 4 includes a first actuator pin 41a coupled with the first latch lock 3, a second actuator pin 41b coupled with the second latch lock 3′, a first actuator pad 42 coupled with the first actuator pin 41a, a second actuator pad 45 coupled with the second actuator pin 41b, and a pad lock 43 coupled with the first actuator pad 42. The second actuator pad 45 is slidably received partially in the first actuator pad 42 and is biased away from the first actuator pad 42 by a biasing member 46 (e.g. a compression spring). The pad lock 43 is biased into engagement with the second actuator pad 45 by a biasing member 44 (e.g. a torsion spring). The pad lock 43 is movable relative to the first and second actuator pads 42, 45 between a locked position engaged with the second actuator pad 45 and a released position disengaged with the second actuator pad 45. Specifically, the pad lock 43 is pivotable relative to the actuator pads 42, 45 and is configured to be pulled outwardly away from the actuator pins 41 to free the second actuator pad 45 for translation relative to the first actuator pad 42. With the pad lock 43 in the released position, the second actuator pad 45 can be pushed against the force by biasing element 46 to bring the first and second actuator pins 41a, 41b closer to one another. The actuator pins 41a, 41b are received in the guide slots 34, 34′ to cause movement of the latch locks 3, 3′ in response to such movement.

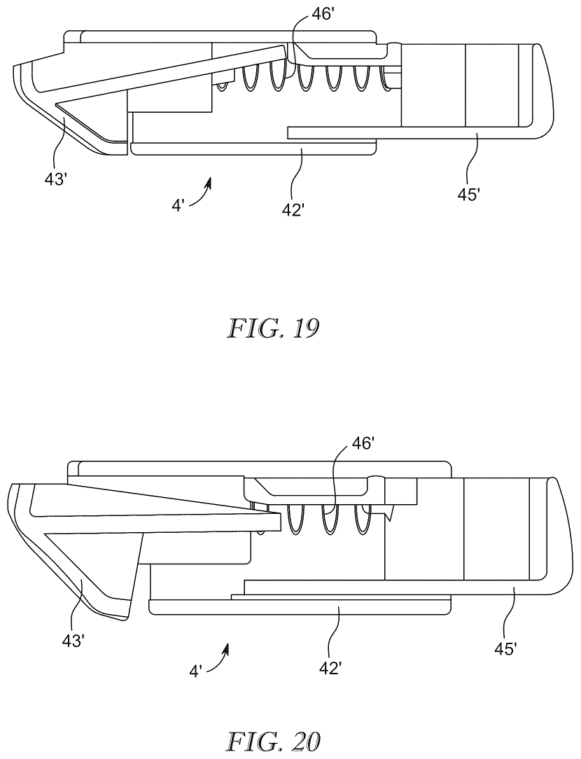

Another embodiment of a release actuator 4′ that can be used with the seat anchor 110 is shown in FIGS. 19 and 20. The release actuator 4′ includes a first actuator pad 42′ coupled with the first actuator pin 41a, a second actuator pad 45′ coupled with the second actuator pin 41b, and a pad lock 43′ coupled with the first actuator pad 42′. Operation of the release actuator 4′ is similar to release actuator 4 except that the pad lock 43′ is pivotable toward the first and second actuator pins 41a, 41b to release from the second actuator pad 45′ and free the second actuator pad 45′ for translation relative to the first actuator pad 42′.

One objective of the present disclosure is to provide a double-headed Isofix interface connector with a simple structure, simple operation and convenient use. The objective of the present disclosure is achieved through the following technical measures: A double-headed Isofix interface connector including a pair of locks, hinged to both ends of the installation housing, and both of these locks have a locking position that can be clamped onto the car seat lock rod to close the crocodile mouth and an unlocking position that can be unclamped to open the crocodile mouth. A pair of connecting pieces, located within the installation housing and between the pair of locks, can be respectively interlocked with the corresponding locks. An unlocking operating piece is provided on the installation housing and has a pair of operating rods for respectively controlling the corresponding connecting pieces during unlocking.

When one end of the lock changes from the unlocked position to the locked position, the connection piece corresponding to the lock is linked to make it resist the lock to lock, while the other end of the lock remains in the unlocked position. At this time, the connector is in use. When the lock in the locked position needs to be changed to the unlocked position, by operating the unlocking operating piece to make the operating lever control the corresponding connecting piece and the lock to be linked and release the lock on it, the lock at the other end remains in the unlocked position. At this time, the connector is in a non-usable state.

The present disclosure provides a positioning structure for defining the relative position between the connector and the child seat when the connecting parts are in use. When the connector is not in use, both positioning structures are in the positioning state. When not in use, by operating the unlocking control piece, the two control levers can control the corresponding connecting pieces to release the positioning state of the two positioning structures. At this time, the position of the child seat relative to the connector can be adjusted. When the connector changes from the non-use state to the use state, that is, when one end of the lock changes from the unlocked position to the locked position, the positioning state of the positioning structure on the corresponding connecting piece is released, while the positioning structure on the connecting piece corresponding to the other end of the lock remains in the positioning state.

The pair of connecting pieces of the present disclosure are respectively in the first position and the second position when the corresponding lock is in the unlocking position and the locking position, and respectively resist the first part and the second part of the lock. The connecting piece and the corresponding lock are connected by a tension spring. When the lock changes between the unlocking position and the locking position, the connecting parts are pulled by the tension spring and interlocked between the first position and the second position, and respectively rub against the first part and the second part of the lock.

The lock head of the present disclosure is a sheet or plate body. The outer side of the lock head has an opening for accommodating the lock rod of a car seat. The bottom of the opening has a protrusion for cooperating with the lock rod of a car seat. The outer end of the opening is a hook part that bends inward. The inner bottom of the lock head has a concave part and above the concave part is a convex part. The convex part is the first part of the lock head. The described concave part is the second part of the lock head.

The connecting piece of the present disclosure is a rod or arm piece, which includes an arc-shaped rod section, cross rod section and special-shaped grooves connected in sequence. The outer end of the arc-shaped rod sections is in contact with the first and second parts of the lock head. Each operating rod is adapted to pass through the special-shaped grooves corresponding to the connecting piece. The operating rod has a third position and a fourth position relative to the special-shaped grooves. When the lock head is respectively in the unlocked position and the locked position, the operating lever is in the third and fourth positions in the special-shaped groove.

The special-shaped groove of the present disclosure is an inclined groove. The bottom end of the special-shaped groove is at the third position, and the upper part of the special-shaped groove is at the fourth position. When the connecting piece changes from the first position to the second position, the corresponding operating rod slides from the bottom end to the upper part relative to the special-shaped groove.

The positioning/lock tab structure of the present disclosure is a block or tab on the top surface of the transverse rod section of the connecting part in the illustrative embodiment. The inner side of the lock tab is a vertical surface and the outer side is an inclined surface. A long strip-shaped opening corresponding to the lock tab is provided on the top surface of the installation shell. The positioning state of the lock tab is that the lock tab passes through the opening and is clamped in the clamping hole set on the car seat. The release of the positioning state of the lock tab refers to the lock tab being detached from the card hole.

The unlocking operation component of the present disclosure comprises a base body, a first key body and a second key body arranged on the base body. The first key body and the second key body respectively have an operation lever. On the two side walls of the installation shell, there are two pairs of long strip-shaped sliding holes that are opposite. Each operation lever extends into a pair of sliding holes and can move along the sliding holes. When the lock is in the unlocked position and the locked position, the corresponding operating lever is at the outer end of the sliding hole. When one end of the lock needs to change from the locked position to the unlocked position, the operating lever corresponding to the lock is controlled to move from the outer end to the inner end of the sliding hole by operating the unlocking operating piece, and at the same time drive the connecting piece to revoke the resistance against the lock and release the lock. At the same time, control the other operating lever to move from the outer end to the inner end of the sliding hole and along the bevel of the special-shaped groove to press down the connecting piece and make the lock tab detach from the card hole. At this time, the position of the child seat relative to the connector can be adjusted. After the force applied to the unlocking operating piece is removed, the two operating levers move from the inner end to the outer end of the sliding hole, and at the same time, the connecting piece is pulled by the tension spring to move to the first position.

The length of the opening on the installation shell of the present disclosure satisfies the travel distance of the lock tab in the opening when the lock changes from the unlocked state to the locked state. At this time, the lock tab moves to the outer end of the opening, and simultaneously satisfies the travel distance of the lock tab in the opening when the operating lever moves from the fifth position to the sixth position during the process of the lock changing from the locked state to the unlocked state. At this point, the lock tab moves to the inner end of the opening.

The present disclosure is equipped with a fixed frame that can be fixed on a child seat on the outside of the connector. The top surface of the fixed frame has a card hole. The connector can slide along the arrangement direction of the tab holes in the fixed frame, or the connector can be slidably installed in the fixed frame set on the child seat. The top surface of the fixed frame has a card hole, and the connector can slide along the arrangement direction of the tab holes.

The present disclosure provides two pairs of upper and lower limit blocks on the inner wall of the installation shell. The arc-shaped rod segment of each connecting piece passes through between a pair of limit blocks, and the distance between the pair of limit blocks is greater than the width of the arc-shaped rod segment, so as to provide vertical displacement space for the connecting piece when it changes between the first position and the second position.

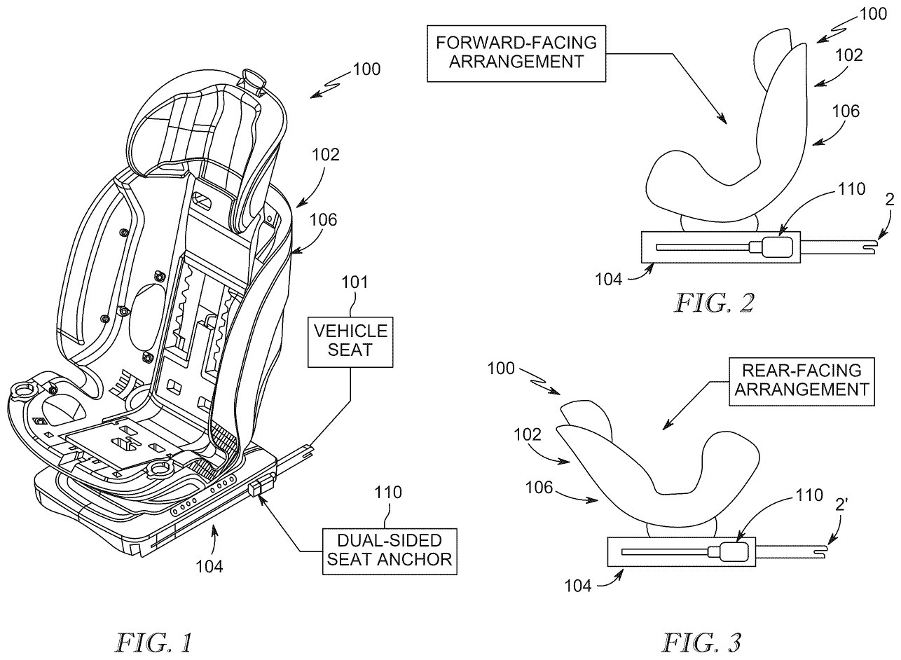

As shown in FIGS. 1 to 20, the child restraint includes a dual-head Isofix interface connector of the present disclosure, which is used to connect the child seat to a vehicle seat. This connector may include an installation housing 1, a pair of lock heads 2, a pair of connecting pieces 3 and an unlocking operation piece 4. The installation housing 1 is a long and flat housing, with crocodile mouths 11 at both ends. The pair of lock heads 2 are hinged at both ends of the installation housing 1, and both have the functions of clamping on a car seat lock rod to close the locking position of the crocodile mouth 11 and removing the clamping to open the unlocking position of the crocodile mouth 11. The pair of connecting pieces 3 is located inside the installation housing 1 and between the pair of locks 2, and can be interlocked with the corresponding locks 2 respectively. The unlocking operation piece 4 is set on the installation housing 1 and has a pair of operation levers 41 for respectively controlling the corresponding connecting piece 3 during unlocking.

When the lock head 2 at one end changes from the unlocked position to the locked position, the corresponding connecting piece 3 of the lock head 2 is linked to make it resist the lock head 2 to lock, while the lock head 2 at the other end remains in the unlocked position. At this time, the connector is in use. When the lock head 2 in the locked position needs to be changed to the unlocked position, by operating the unlock operating piece 4, the operating lever 41 is made to control the corresponding connecting piece 3 and the lock head 2 to be linked and unlock it. The lock head 2 at the other end remains in the unlocked position. At this time, the connector is in a non-usable state.

The pair of connecting pieces 3 are respectively in the first position and the second position when the corresponding lock 2 is in the unlocking position and the locking position, and respectively rub against the first part 21 and the second part 22 of the lock 2. The connecting piece 3 and the corresponding lock 2 are connected through a tension spring 5. When the lock 2 changes between the unlocking position and the locking position, the connecting part 3 is pulled by the tension spring 5 and interlocked between the first position and the second position, and respectively rub against the first part 21 and the second part 22 of the lock head 2.

The lock head 2 includes an irregularly shaped sheet body. On the outside of the lock head 2, there is an opening 23 for accommodating the car seat lock rod. At the bottom of the opening 23, there is a protrusion 24 for cooperating with the car seat lock rod. When the lock rod of the car seat touches the protrusion 24 at one end of the lock head 2, because the protrusion 24 is an arc surface and functions similar to a cam, the lock head 2 rotates around the hinge point 6. So as to keep the lock in the locked position. The outer end of the opening 23 is a hook part 25 that bends inward, making the opening roughly in the shape of a 7. When the lock is closed, the hook part 25 closes with the crocodile mouth 11 of the installation housing, fastening the lock lever of the car seat into the opening 23 of the lock. The inner bottom of lock 2 has a concave part, and above the concave part is a convex part. The convex part is the first part 21 of lock 2, and the concave part is the second part 22 of lock 2.

Both of the connecting pieces 3 have a positioning structure 31 for limiting the relative position between the connector and the child seat. When the connector is not in use, both positioning structures are in the positioning state, that is, the child seat is not allowed to move relative to the connector. When not in use, by operating the unlocking control piece, the two control levers can control the corresponding connecting pieces to release the positioning state of the two positioning structures. At this time, the position of the child seat relative to the connector can be adjusted. When the connector changes from the non-use state to the use state, that is, when one end of the lock changes from the unlocked position to the locked position, the positioning state of the positioning structure on the corresponding connecting piece is released. Meanwhile, the positioning structure on the connecting piece corresponding to the other end of the lock remains in the positioning state, that is, the child seat is not allowed to move away from the connector.

In this embodiment, the connecting piece 3 is a member, which includes an arc-shaped rod section 32, a crossbar section 33 and an irregular groove 34 connected in sequence. The outer end of the arc-shaped rod section 32 is in contact with the first part 21 and the second part 22 of the lock head 2. Each operating rod 41 is adapted to pass through the irregular groove 34 corresponding to the connecting piece 3. The operating lever 41 has a third position and a fourth position relative to the special-shaped slot 34. When the lock head 2 is respectively in the unlocking position and the locking position, the operating lever 41 is in the third position and the fourth position in the special-shaped slot 34. In this embodiment, the special-shaped groove 34 is an inclined groove. The bottom of the special-shaped groove 34 is at the third position, and the upper part of the special-shaped groove 34 is at the fourth position. When the connecting piece 3 changes from the first position to the second position, the corresponding operating rod 41 slides from its bottom to the upper part relative to the special-shaped groove 34.

In this embodiment, the positioning structure 31 is a lock tab set on the top surface of the transverse rod section 33 of the connecting piece 3. The inner side of the lock tab is a vertical surface, and the outer side is an inclined surface. A long strip-shaped opening 12 corresponding to the lock tab is provided on the top surface of the installation shell 1. The positioning state of the lock tab is that the lock tab passes through the opening 12 and is clamped in the clamping hole set on the car seat. The release of the positioning state of the lock tab refers to the lock tab being detached from the card hole.

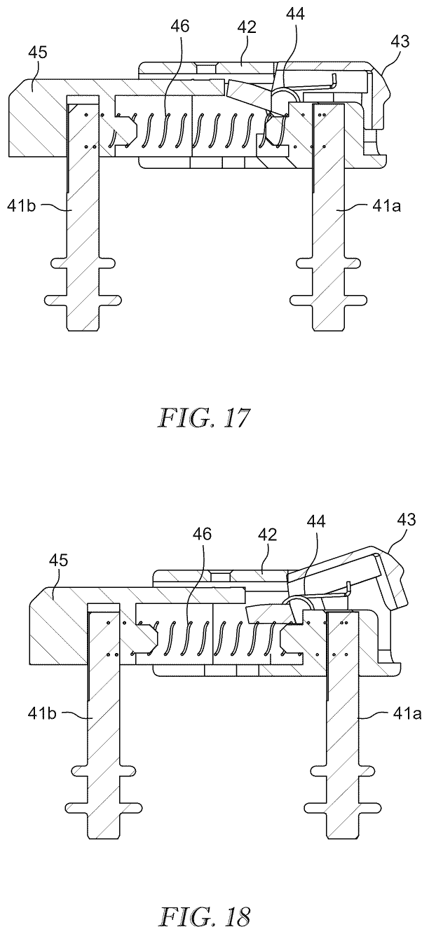

The unlocking operation part 4 includes the seat body 42, the first key body and the second key body set on the seat body 42 as shown in FIGS. 17 and 18. The first key body and the second key body each have an operation lever. The first key body includes the first key 43, the torsion spring 44 and the first operation lever 41a. The main body of the second key includes the second key 45, the spring 46 and the second operating lever 41b. The first key 43 is rotatably installed on the base 42. The first key 43 has a socket. The second key 45 is sliding and set on the base 42. The second key 45 has a plug-in that matches the jack. One end of the torsion spring 44 is connected to the base body 42, and the other end of the torsion spring 44 is connected to the first key 43. The torsion spring 44 is used to drive the first key 43 to reset. One end of spring 46 is connected to the base 42, and the other end of spring 46 is connected to the second key 45. Spring 46 is used to drive the second key 45 to reset. One end of the first operating lever 41a is fixedly installed on the seat 42, and one end of the second operating lever 41b is fixedly installed on the second key 45. On the two side walls of the installation shell 1, there are two pairs of long strip-shaped sliding holes 13 in opposite directions. Each operating rod 41 extends into a pair of sliding holes 13 and can move along them. At the extension end of the operating rod 41, there is a pair of limit flanges 47 located on both sides of the special-shaped groove 34, so that the special-shaped groove 34 is clamped between the two limit flanges 47.

When the lock 2 is in the unlocked position and the locked position, the corresponding operating lever 41 is at the outer end of the sliding hole 13. When one end of the lock 2 needs to change from the locked position to the unlocked position, by operating the unlocking operation piece, the operation lever 41 corresponding to this lock head is controlled to move from the outer end to the inner end of the sliding hole 13, while driving the connecting piece 3 to withdraw the resistance against this lock head 2 and release the lock. At the same time, another operation lever 41 is controlled to move from the outer end to the inner end of the sliding hole 13 and move along the bevel of the special-shaped groove 34 to press down the connecting piece 3 and make the lock tab detach from the card hole. At this point, the position of the child seat relative to the connector can be adjusted. After the force applied to the unlocking operating part is removed, the two operating rods 41 move from the inner end to the outer end of the sliding hole 13, and at the same time, the connecting part 3 is pulled and moved to the first position by the tension spring 5.

The length of the opening 12 on the installation shell 1 meets the travel distance of the lock tab's displacement in the opening 12 when the lock head 2 changes from the unlocked state to the locked state. At this time, the lock tab moves to the outer end of the opening 12, and simultaneously meets the travel distance of the lock tab's displacement in the opening 12 when the operating lever 41 moves from the outer end to the inner end of the sliding hole during the process of the lock head 2 changing from the locked state to the unlocked state.

On the inner wall of the installation shell 1, there are two pairs of upper and lower limit blocks 14. The arc-shaped rod segment 32 of each connecting piece 3 passes between a pair of limit blocks 14, and the distance between this pair of limit blocks 14 is greater than the width of the arc-shaped rod segment 32, so as to provide vertical displacement space for the connecting piece when it changes between the first position and the second position.

The relative position of the connector of the present disclosure and the child seat can be adjusted to make the present disclosure applicable to different types of automotive seats. In this embodiment, the external installation of the connector of the present disclosure can be fixed on the fixed frame 7 of the child seat. The left and right ends of the fixed frame 7 are open, and the top surface of the fixed frame 7 has several tab holes 71. The connector can slide along the arrangement direction of the tab holes 71 in the fixed frame 7 and extend from the left or right end of the fixed frame. By inserting the lock tabs into the tab holes, the connector is fixed inside the fixed frame.

In other embodiments, no fixed frame is installed on the outside of the connector of the present disclosure. Instead, a fixed frame is provided on the child seat. When in use, the connector of the present disclosure is slid and installed in the fixed frame. The top surface of the fixed frame has several tab holes, and the connector can slide along the arrangement direction of the tab holes.

The working principle and usage process of the present disclosure are as follows: The connector is in an unused state (both locks at both ends are in the unlocked position and both lock tabs are in the positioned state. At this time, the child seat is not allowed to move relative to the connector) as shown in FIGS. 7-11. When the ISOFIX connector is not connected to the lock lever of the car seat, both lock heads at both ends are in the unlocked position, and both lock tabs are in the positioned state. At this time, the lock tabs extend into the tab holes of the fixed frame. Both operating rods are located at the outer end of the slots at the same time, both operating rods are located at the bottom end of the special-shaped groove, that is, at the third position in the special-shaped groove. Because the vertical surfaces of the two lock tabs are in contact with the inner walls of the corresponding tab holes, the connector cannot move left and right within the fixed frame. At this point, both connecting parts are in the first position and are in contact with the first part of the corresponding lock, that is, with the protruding part of the lock.

The connector changes from an unused state to an used state (used state: One end of the lock is in the locked position and the positioning state of this side lock tab is released, the other end of the lock is in the unlocked position and the positioning state of this side lock tab. At this time, the child seat is not allowed to move away from the connector), as shown in FIGS. 15 and 16, but the child seat can still move toward the latch in the locked position. When connecting the ISOFTX connector to the lock lever of the car seat, switch the ISOFIX connector from the unused state to the used state. Take the lock head on the left end and the lock lever snap of the car seat as an example:

The lock rod presses against the protrusion of the lock head, causing the lock head to rotate counterclockwise. Under the pull of the tension spring, the connecting part slides into the concave part. At the same time, the lock tab is pressed down by the wall of the clamping hole and slides out of the clamping hole. When the lock tab moves down, the rear end of the connecting part moves down as a whole, and the special-shaped groove also moves down accordingly. The operating rod slides relatively along the special-shaped groove to its upper part, and the operating rod remains at the left end of the sliding hole.

Meanwhile, the lock on the right end remains in the unlocked position, the lock tab still extends into the card hole, and the operating lever is still at the right end of the sliding hole and at the bottom of the irregular slot. Since the left end of the card slot is in contact with the upright surface of the lock tab, the connector cannot move to the left within the fixed frame. That is to say, the child seat is not allowed to move away from the vehicle lock bar. However, since the right end of the card slot is in contact with the inclined surface of the lock tab, which can cause the lock tab to disengage from the card slot, the connector can move to the right within the fixed frame, that is, allowing the child seat to move closer to the lock rod. Thus, the gap between the lock head and the sitting surface of the car seat is shortened, that is, the distance between the child seat backrest and the sitting surface of the car seat is reduced.

Referring to FIGS. 17 and 18, the release actuator 4 is operated to change the connector from the in use state to the unused state. When it is necessary to unlock the ISOFIX connector from the anchor point of the car seat, the ISOFIX connector switches from the in use state to the unused state. Similarly, taking the unlocking of the lock head and the lock lever on the left end as an example: First, rotate the first key of the unlock operation piece outward to align the jack with the plug-in of the second key. Then, push the second key to move inward. The plug-in of the second key will be inserted into the socket, simultaneously driving the second operating lever and the first operating lever to move relatively (the first operating lever moves relatively with the seat and the second key). Among them, the second operating lever moves from the right end to the left end of the slide hole. The movement of the second operating rod will drive the displacement of the connecting piece (because the second operating rod contacts the beveled edge of the special-shaped groove, when the second operating rod slides horizontally to the left, the connecting piece will move downward), causing the lock tab to detach from the clamping hole. At this time, the second operating rod moves to the upper part of the special-shaped groove.

Meanwhile, the first operating lever will also move from the left end to the right end of the sliding hole (the first operating lever is still above the irregular groove), thereby driving the connecting piece to move to the right, causing the connecting piece to detach from the concave part of the lock head. At this time, under the pull of the tension spring, the lock head rotates clockwise, and the lock head separates from the lock rod, completing the unlocking. At this point, both lock tabs are detached from the tab holes, and the positioning state is released.

Finally, release the first and second keys. Under the action of the spring and torsion spring, the first and second keys reset, causing the first and second operating levers to return to their original positions. The two connecting parts also return to the first position under the restoring force of the tension spring. The two clips re-insert into the slots, and the ISOFIX connector changes from the used state to the unused state. At this point, the two lock tabs are in the positioning state. To adjust the relative position of the connector to the child seat: When the connector is in use or not in use, the position of the connector within the fixed frame can be adjusted by simultaneously pressing the first and second buttons on both sides.

1. A child restraint comprising:
a seat base adapted to rest on a vehicle seat,
a juvenile seat coupled to the seat base and formed to include a child receiving space configured to receive a child to support the child for transportation in a vehicle, and
a seat anchor coupled to the seat base and configured to attach to a vehicle seat anchor point to at least partially secure the child restraint to the vehicle seat, the seat anchor including an anchor housing coupled to the seat base for movement therewith, a latch motion controller coupled to the anchor housing, a first anchor latch coupled to a first end of the latch motion controller, and a second anchor latch coupled to an opposite second end of the latch motion controller,
wherein the seat base, the juvenile seat, and the seat anchor are movable in unison between a forward-facing arrangement and a rearward-facing arrangement, and wherein the latch motion controller, the first anchor latch, and the second anchor latch are configured to translate relative to seat base, the juvenile seat, and the anchor housing from a forward-facing attachment configuration, in which the first anchor latch is withdrawn from the anchor housing for attachment with the vehicle seat anchor point and the second anchor latch is received in the anchor housing when the child restraint is in the forward-facing arrangement, to a rearward-facing attachment configuration, in which the first anchor latch is received in the anchor housing and the second anchor latch is withdrawn from in the anchor housing for attachment with the vehicle seat anchor point when the child restraint is in the rearward-facing arrangement.

2. The child restraint of claim 1, wherein the latch motion controller includes a carrier having the first end and the opposite second end, a first latch lock coupled to the carrier and configured to move the first anchor latch from a locked position engaged with the vehicle seat anchor point in the forward-facing arrangement to a released position freeing the first anchor latch from the vehicle seat anchor point, and a second latch lock coupled to the carrier and configured to move the second anchor latch from a locked position engaged with the vehicle seat anchor point in the rearward-facing arrangement to a released position freeing the second anchor latch from the vehicle seat anchor point.

3. The child restraint of claim 2, wherein the latch motion controller further includes a release actuator extending between first latch lock and the second latch lock and configured to be gripped and actuated by a user to move the first and second latch locks to cause movement of at least one of the first anchor latch and the second anchor latch from the locked position to the released position.

4. The child restraint of claim 3, wherein first latch lock and the second latch lock each include a lock arm configured to engage each respective anchor latch when each respective anchor latch is in the locked position to block movement of each respective anchor latch from the locked position to the released position, an arm-motion guide coupled with the release actuator and configured to be moved by the release actuator to cause movement of each lock arm relative to each respective latch lock, and a lock tab coupled to the lock arm and configured to engage selectively with the anchor housing to block translation of the latch motion controller and the first and second anchor latches relative to the anchor housing.

5. The child restraint of claim 4, wherein the arm-movement guide is formed to include a guide slot configured to cause movement of the lock arm and the lock tab in a first direction in response to movement of at least a portion of the release actuator in a second direction different than the first direction.

6. The child restraint of claim 4, wherein the lock tab is formed integrally with the lock arm.

7. The child restraint of claim 1, wherein the latch motion controller is further movable relative to the anchor housing to a storage configuration in which the first anchor latch and the second anchor latch are both withdrawn into the anchor housing.

8. The child restraint of claim 1, wherein the anchor housing is integrated into the seat base such that at least a portion of the anchor housing and at least a portion of the seat base defines a storage cavity configured to receive the first anchor latch in the rearward-facing attachment configuration and the second anchor latch in the forward-facing attachment configuration.

9. The child restraint of claim 1, wherein the seat anchor further includes an indicator configured to display an indication when at least one of the first anchor latch and the second anchor latch is in a predetermined position relative to the anchor housing.

10. A child restraint comprising:
a seat shell adapted to rest on a vehicle seat and formed to include a child receiving space configured to receive a child to support the child for transportation in a vehicle, and
a seat anchor coupled to the seat shell and configured to attach to a vehicle seat anchor point to at least partially secure the child restraint to the vehicle seat, the seat anchor including an anchor housing coupled to the seat shell for movement therewith, an latch motion controller coupled to the anchor housing, a first anchor latch coupled to a first end of the latch motion controller, and a second anchor latch coupled to an opposite second end of the latch motion controller,
wherein the seat shell and the seat anchor are movable in unison between a forward-facing arrangement and a rearward-facing arrangement, and wherein the latch motion controller, the first anchor latch, and the second anchor latch are configured to move in unison relative to seat shell and the anchor housing from a forward-facing attachment configuration, in which the first anchor latch is withdrawn from the anchor housing for attachment with the vehicle seat anchor point and the second anchor latch is received in the anchor housing when the child restraint is in the forward-facing arrangement, to a rearward-facing attachment configuration, in which the first anchor latch is received in the anchor housing and the second anchor latch is withdrawn from in the anchor housing for attachment with the vehicle seat anchor point when the child restraint is in the rearward-facing arrangement.

11. The child restraint of claim 10, wherein the latch motion controller includes a carrier having the first end and the opposite second end, a first latch lock coupled to the carrier and configured to move the first anchor latch from a locked position engaged with the vehicle seat anchor point in the forward-facing arrangement to a released position freeing the first anchor latch from the vehicle seat anchor point, and a second latch lock coupled to the carrier and configured to move the second anchor latch from a locked position engaged with the vehicle seat anchor point in the rearward-facing arrangement to a released position freeing the second anchor latch from the vehicle seat anchor point.

12. The child restraint of claim 11, wherein the latch motion controller further includes a release actuator extending between first latch lock and the second latch lock and configured to be gripped and actuated by a user to move the first and second latch locks to cause movement of at least one of the first anchor latch and the second anchor latch from the locked position to the released position.

13. The child restraint of claim 12, wherein first latch lock and the second latch lock each include a lock arm configured to engage each respective anchor latch when each respective anchor latch is in the locked position to block movement of each respective anchor latch from the locked position to the released position, an arm-motion guide coupled with the release actuator and configured to be moved by the release actuator to cause movement of each lock arm relative to each respective latch lock, and a lock tab coupled to the lock arm and configured to engage selectively with the anchor housing to block translation of the latch motion controller and the first and second anchor latches relative to the anchor housing.

14. The child restraint of claim 13, wherein the arm-movement guide is formed to include a guide slot configured to cause movement of the lock arm and the lock tab in a first direction in response to movement of at least a portion of the release actuator in a second direction different than the first direction.

15. The child restraint of claim 13, wherein the lock tab is formed integrally with the lock arm.

16. The child restraint of claim 10, wherein the latch motion controller is movable relative to the anchor housing to a storage configuration in which the first anchor latch and the second anchor latch are both withdrawn into the anchor housing.

17. The child restraint of claim 10, wherein the anchor housing is integrated into the seat shell such that at least a portion of the anchor housing and at least a portion of the seat shell defines a storage cavity configured to receive the first anchor latch in the rearward-facing attachment configuration and the second anchor latch in the forward-facing attachment configuration.

18. A child restraint comprising:
a seat shell adapted to rest on a vehicle seat and formed to include a child receiving space configured to receive a child to support the child for transportation in a vehicle, and
a seat anchor coupled to the seat shell and configured to attach to a vehicle seat anchor point to at least partially secure the child restraint to the vehicle seat, the seat anchor including an anchor housing coupled to the seat shell for movement therewith, an latch motion controller coupled to the anchor housing, a first anchor latch coupled to a first end of the latch motion controller, and a second anchor latch coupled to an opposite second end of the latch motion controller,
wherein the seat shell and the seat anchor are movable in unison between a forward-facing arrangement and a rearward-facing arrangement, and wherein the latch motion controller, the first anchor latch, and the second anchor latch are configured to move in unison relative to the seat shell: (i) in a first direction away from the second latch anchor and when the child restraint is in the forward-facing arrangement to position the first anchor latch for attachment with the vehicle seat anchor point in a forward-facing attachment configuration and (ii) in a first direction away from the first latch anchor and when the child restraint is in the rearward-facing arrangement to position the second anchor latch for attachment with the vehicle seat anchor point in a rearward-facing attachment configuration.

19. The child restraint of claim 18, wherein the anchor housing at least partially defines a storage cavity, and the second anchor latch is received in the storage cavity in the forward-facing attachment configuration and the first anchor latch is received in the storage cavity in the rearward-facing attachment configuration.

20. A method of installing the child restraint of claim 18, the method comprising:
attaching one of the first anchor latch or the second anchor latch to the vehicle seat anchor point,
blocking movement of the child restraint away from the vehicle seat anchor point, and
moving the child restraint toward the vehicle seat anchor point while the one of the first anchor latch or the second anchor latch is attached to the vehicle seat anchor point to decrease a distance between the anchor housing and the vehicle seat anchor point.
